(19) United States
(12) Patent Application Publication
(10) Pub. No.: US 2013/0045296 A1
(43) Pub. Date: Feb. 21, 2013

(54) Mold-Tool System Including Retractable Support Assembly to Reduce Support Force to Runner Assembly

(71) Applicants: Brian Esser, Colchester, VT (US); Manon Danielle Belzile, Fairfield, VT (US)

(72) Inventors: Brian Esser, Colchester, VT (US); Manon Danielle Belzile, Fairfield, VT (US)

(73) Assignee: HUSKY INJECTION MOLDING SYSTEMS LTD., Bolton, ON (CA)

(21) Appl. No.: 13/643,098

(22) PCT Filed: May 3, 2011
(86) PCT No.: PCT/US11/34872

§ 371 Date: Oct. 24, 2012

Related U.S. Application Data
(60) Provisional application No. 61/334,619, filed on May 14, 2010.

(51) Int. Cl. B29C 45/20; B29C 45/76

(52) U.S. Cl. 425/574

(57) ABSTRACT

A mold-tool system (100), comprising: a runner assembly (102); and a retractable-support assembly (104) being at least partially unloaded from the runner assembly (102) so that heat loss from the runner assembly (102) is reduced at least in part.

### TECHNICAL FIELD

An aspect of the present invention generally relates to (but is not limited to) a mold-tool system including (but is not limited to) a mold-tool system including (but not limited to) a runner assembly, and a retractable-support assembly configured to partially reduce a support force to the runner assembly, so that heat loss from the runner assembly is reduced at least in part.

### BACKGROUND

The first man-made plastic was invented in Britain in 1851 by Alexander PARKES. He publicly demonstrated it at the 1862 International Exhibition in London, calling the material Parkesine. Derived from cellulose, Parkesine could be heated, molded, and retain its shape when cooled. It was, however, expensive to produce, prone to cracking, and highly flammable. In 1868, American inventor John Wesley HYATT developed a plastic material he named Celluloid, improving on PARKES' invention so that it could be processed into finished form. HYATT patented the first injection molding machine in 1872. It worked like a large hypodermic needle, using a plunger to inject plastic through a heated cylinder into a mold. The industry expanded rapidly in the 1940's because World War II created a huge demand for inexpensive, mass-produced products. In 1946, American inventor James Watson HENDRY built the first screw injection machine. This machine also allowed material to be mixed before injection, so that colored or recycled plastic could be added to virgin material and mixed thoroughly before being injected. In the 1970's, HENDRY went on to develop the first gas-assisted injection molding process.

Injection molding machines consist of a material hopper, an injection ram or screw-type plunger, and a heating unit. They are also known as presses, they hold the molds in which the components are shaped. Presses are rated by tonnage, which expresses the amount of clamping force that the machine can exert. This force keeps the mold closed during the injection process. Tonnage can vary from less than five tons to 6000 tons, with the higher figures used in comparatively few manufacturing operations. The total clamp force needed is determined by the projected area of the part being molded. This projected area is multiplied by a clamp force of from two to eight tons for each square inch of the projected areas. As a rule of thumb, four or five tons per square inch can be used for most products. If the plastic material is very stiff, it will require more injection pressure to fill the mold, thus more clamp tonnage to hold the mold closed. The required force can also be determined by the material used and the size of the part, larger parts require higher clamping force. With Injection Molding, granular plastic is fed by gravity from a hopper into a heated barrel. As the granules are slowly moved forward by a screw-type plunger, the plastic is forced into a heated chamber, where it is melted. As the plunger advances, the melted plastic is forced through a nozzle that rests against the mold, allowing it to enter the mold cavity through a gate and runner system. The mold remains cold so the plastic solidifies almost as soon as the mold is filled. Mold assembly or die are terms used to describe the tooling used to produce plastic parts in molding. The mold assembly is used in mass production where thousands of parts are produced. Molds are typically constructed from hardened steel, etc. Hot-runner systems are used in molding systems, along with mold assemblies, for the manufacture of plastic articles. Usually, hot-runners systems and mold assemblies are treated as tools that may be sold and supplied separately from molding systems.

U.S. Pat. No. 71,659,58 (Inventor: JENKO; Filed: 23 Apr. 2004) discloses method and apparatus are provided for sealing interfaces within an injection mold having a first surface and a second surface includes an active material actuator configured to be disposed in a manner suitable for generating a force between the first surface and the second surface. The active material actuator is configured to generate a force in response to sense signals from a transmission structure. Methods and apparatus are also provided for centering a nozzle tip within a gate opening, and adjusting tip height of a nozzle tip with respect to a gate opening, also using active material inserts.

United States Patent Publication Number 20080088047 (Inventor: TRUDEAU; filed: 2006-10-12) discloses an apparatus and method for a hot runner injection molding system. The injection molding system has a plurality of melt conveying components defining a melt path from a melt source to a mold cavity and a mold housing. A force sensor or load cell is utilized between at least one melt conveying component of the system and the mold housing to measure a force generated due to thermal expansion of the melt conveying component during start-up and/or operation of the system and to provide an output to a receiving device. In an embodiment, once a sealing load or a predetermined preload force has been reached, an injection molding cycle may begin.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public.

Current hot runner manifold support structures provide structural support all the time. As they are loaded against the manifold at all times, they also act as heat sinks at all times, pulling heat away from the heated components. This arrangement results in a thermal imbalance in the manifold, increased power requirements for heating, and increased cooling capacity for the cooled plates than would otherwise be required. Although the supports are “in place” all the time, their primary purpose if to resist the forces of injection (along with the associated pack/hold phases), which is typically only a small fraction of the injection molding cycle.

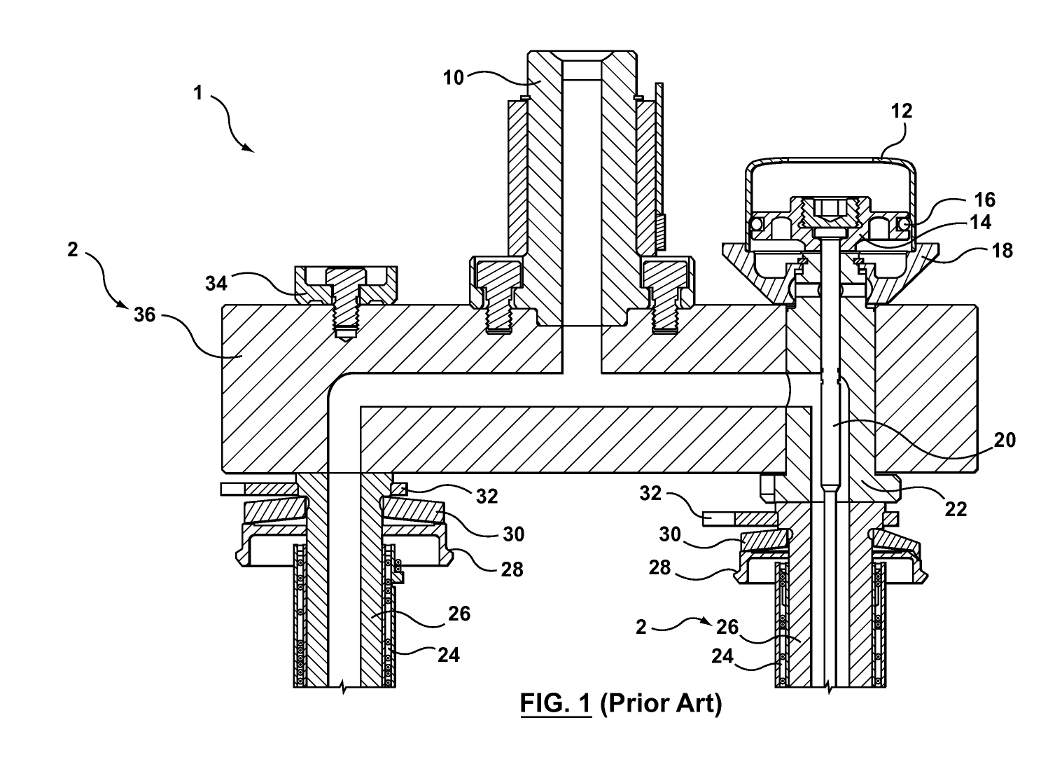

FIG. 1 depicts a schematic representation of a known mold-tool system (1). The mold-tool system (1) may include a runner assembly (2), which may be a hot runner assembly or a cold runner assembly) in combination with a mold assembly (not depicted). The mold-tool system (1) is supported between platens of a mold system (such as an injection molding system). The mold-tool system (1) includes (but is not limited to): the hot-runner assembly (2). The hot-runner assembly (2) may include a nozzle assembly (26) and/or a manifold assembly (36), and/or the manifold assembly (36) in combination with the nozzle assembly (26), all depending on what the end user desires. The mold-tool system (1) may further include: a sprue bushing (10), a cylinder (12), a piston (14), a piston seal (16), a back-up pad (18), a valve stem (20), a manifold bushing (22), a nozzle heater (24), a locating insulator (28), a seal (30), an anti-rotation ring (32), and a back-up insulator (34). The inventors have identified that backup pads components and insulator components lose a significant amount of heat while the mold-tool system (1) is used, and may result in wasted energy and contributes to imbalance of melt flow through the mold-tool system (1).

According to one aspect, there is provided a mold-tool system (100), comprising: a runner assembly (102); and a retractable-support assembly (104) being configured to partially reduce a support force (107) to the runner assembly (102), so that heat loss from the runner assembly (102) is reduced at least in part.

A technical effect of the above-identified aspect is that the manifold-support assembly may provide support to the manifold assembly during different cycles of a molding operation, such as during injection phase, and at other times (during operation), the manifold-support assembly may become a locating feature (for example). By having the manifold-support assembly provide a support force during the injection phase (for example), waste of heat and/or melt-flow variability may be reduced.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

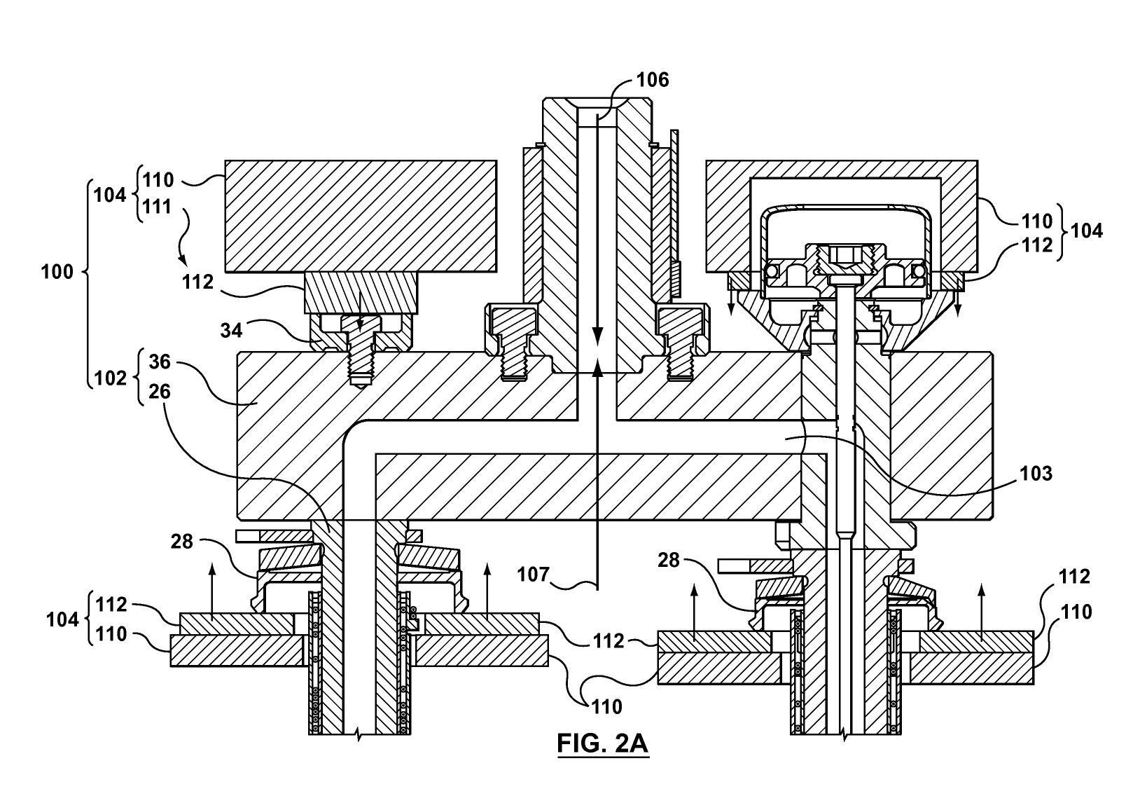

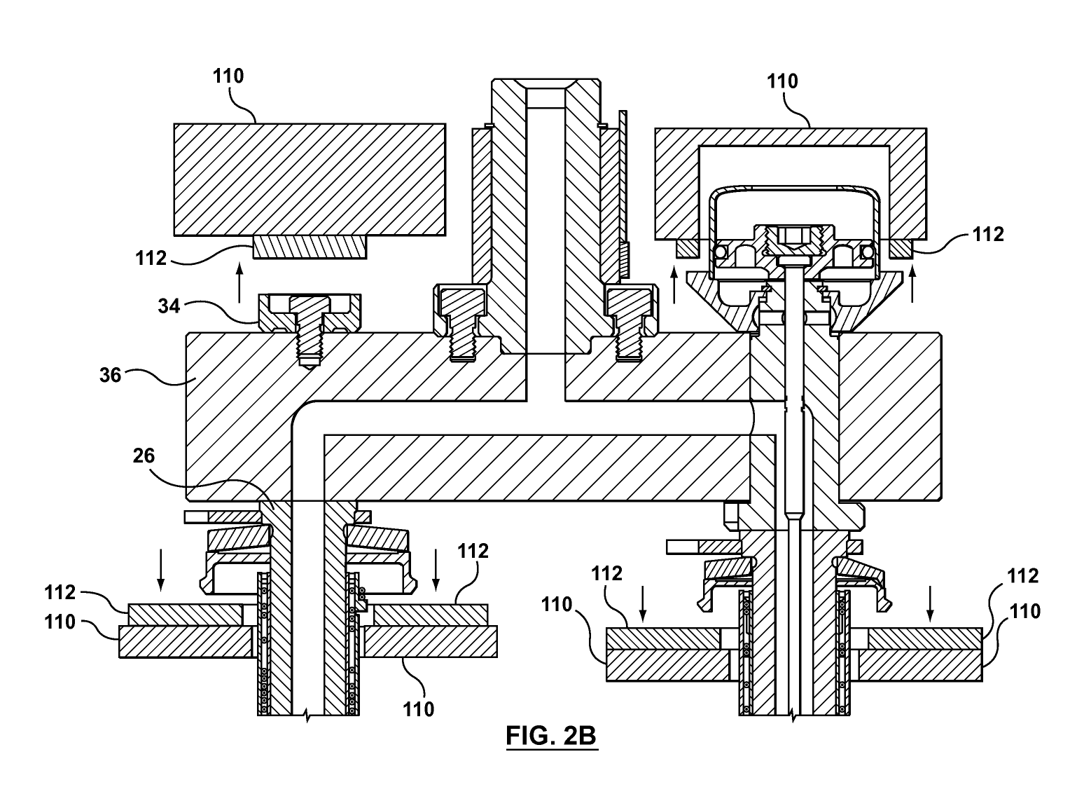

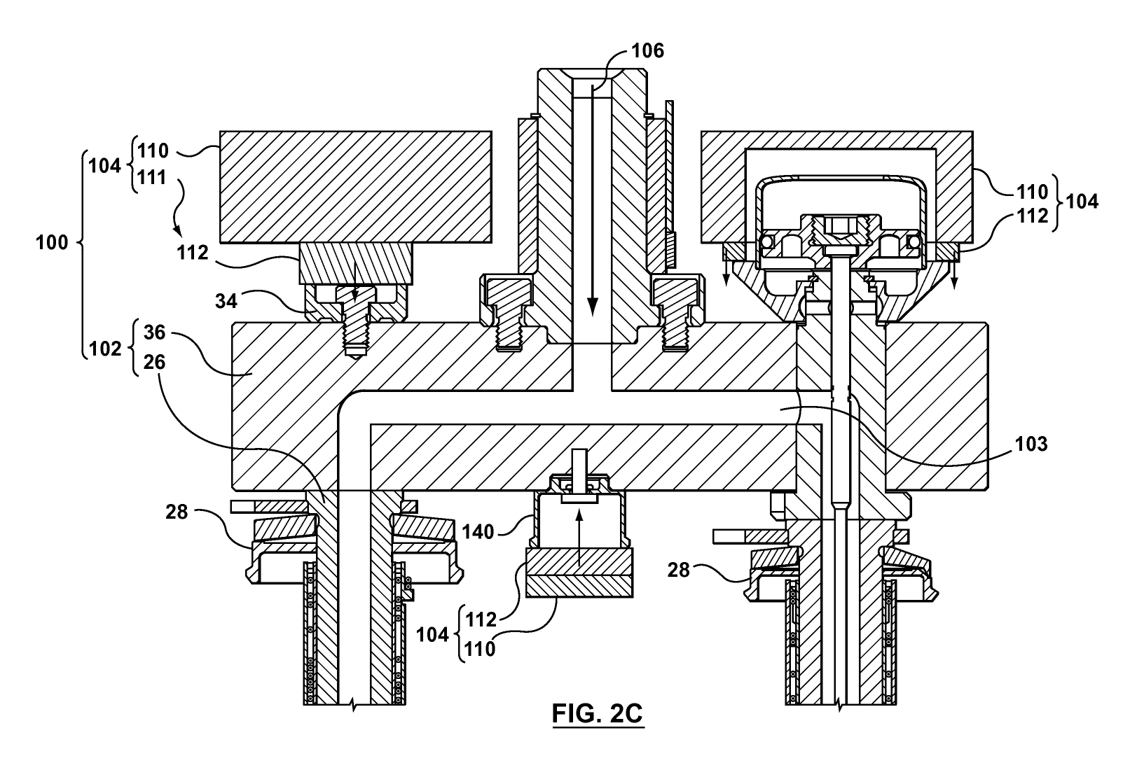

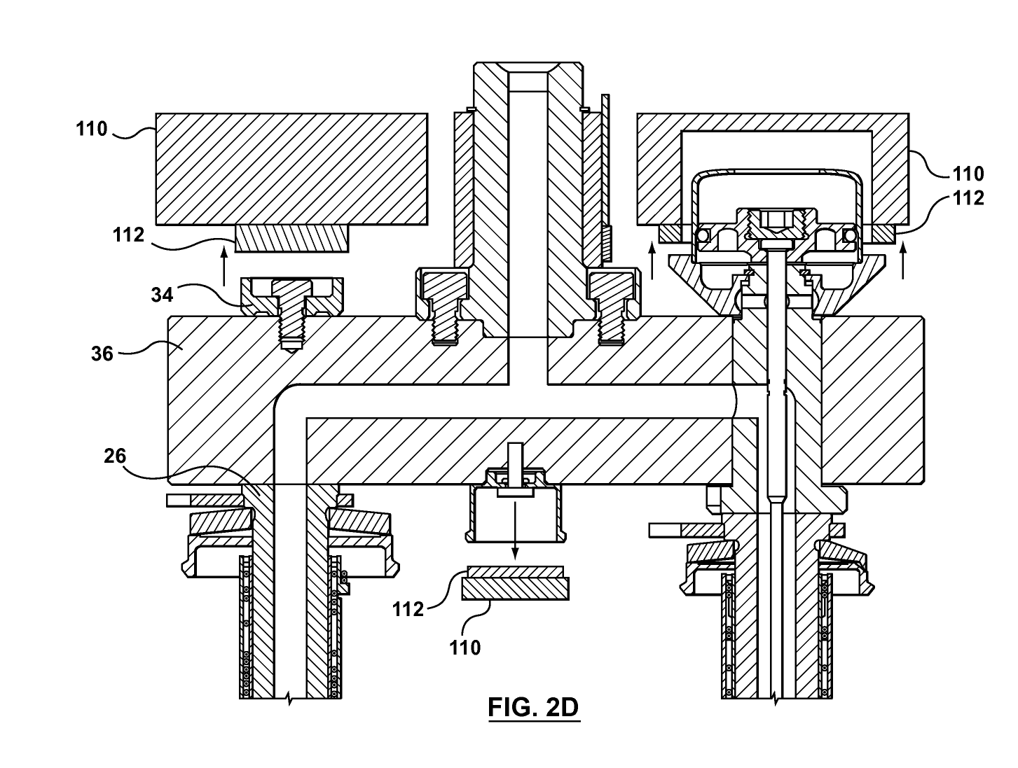

FIGS. 2A, 2B, 2C, 2D depict schematic representations of a mold-tool system (100).

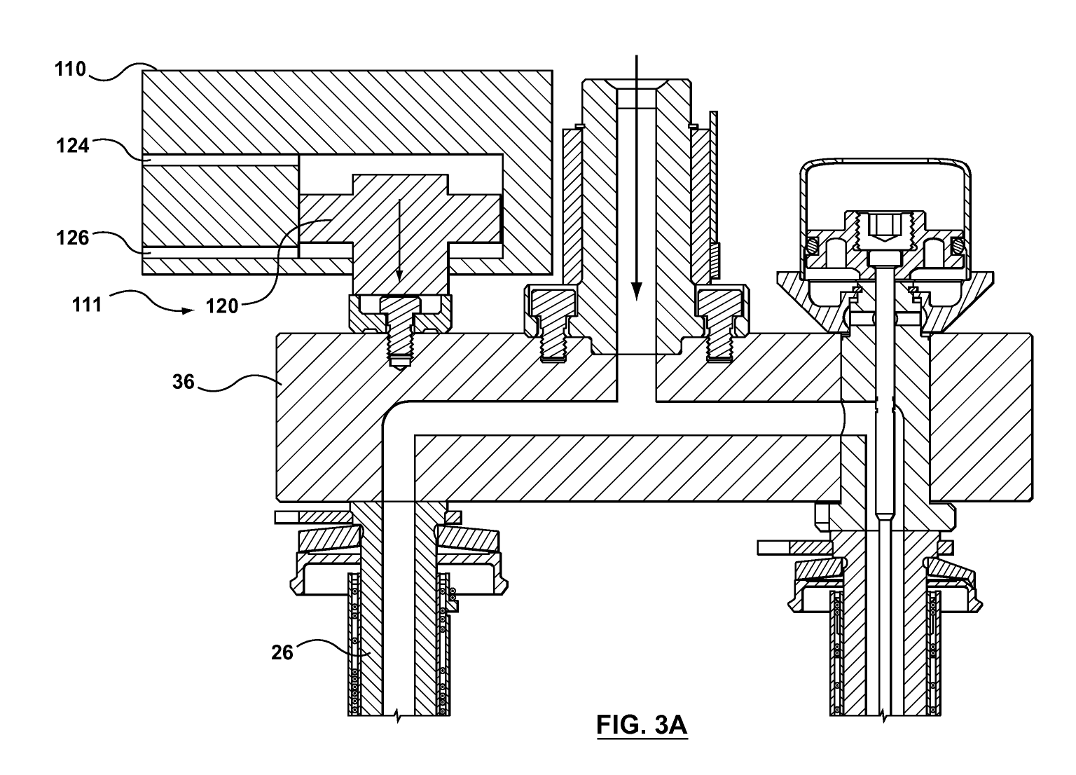

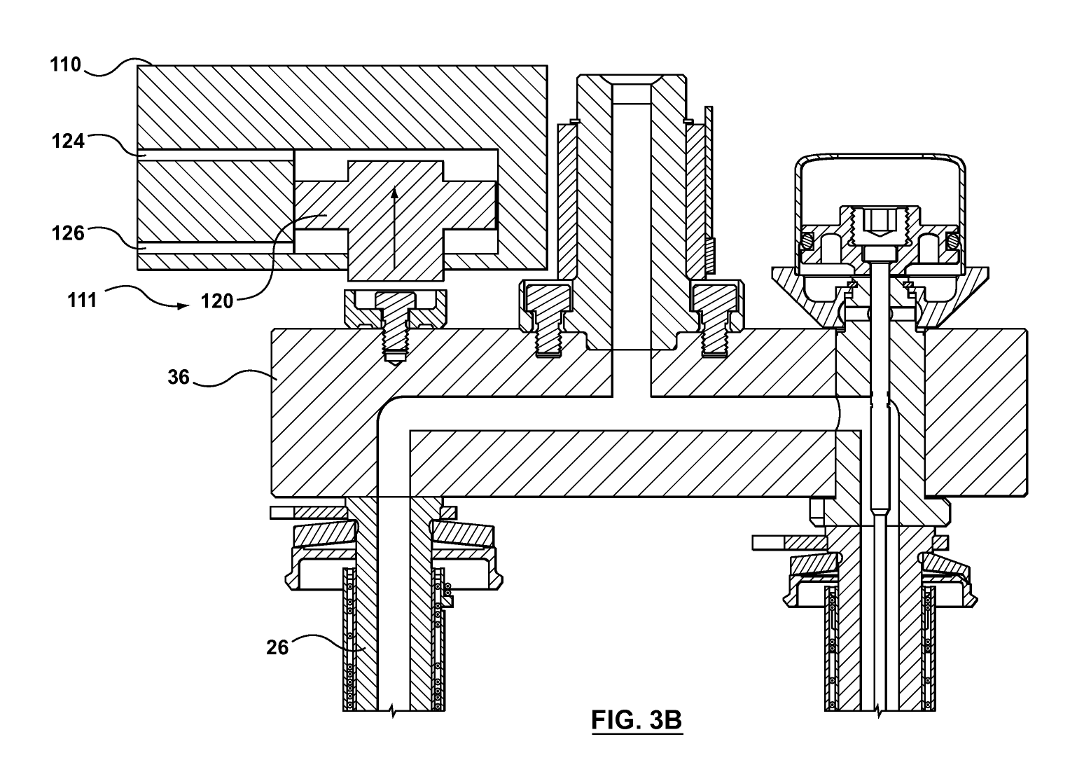

FIGS. 3A and 3B depict a schematic representation of the mold-tool system (100);

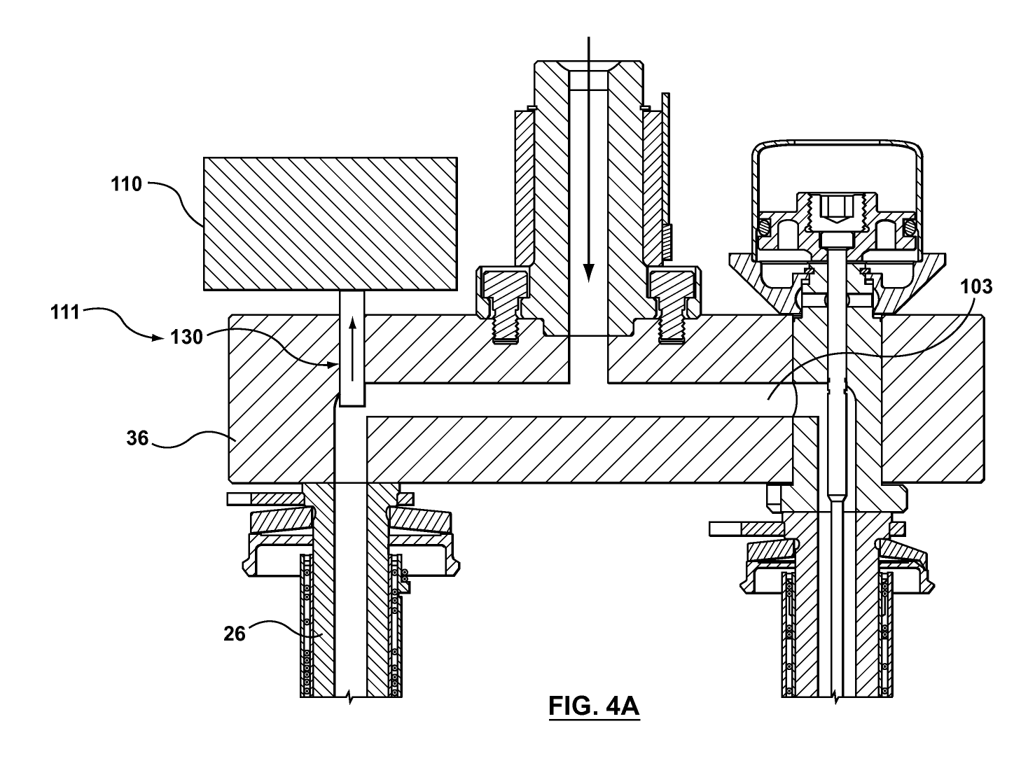

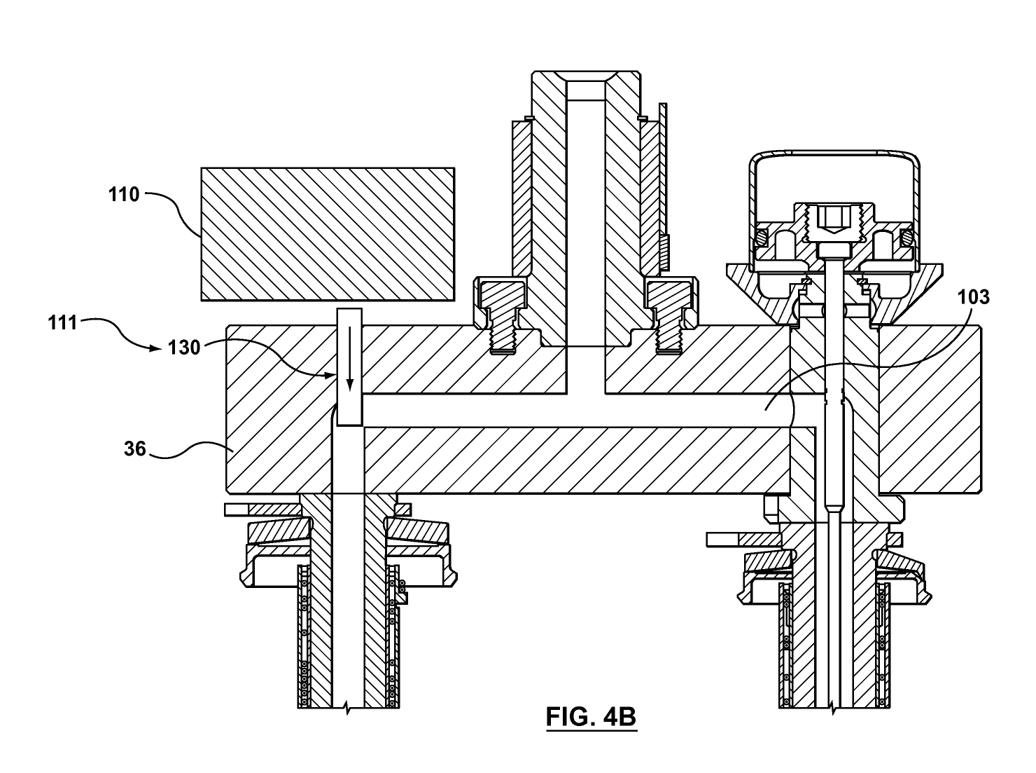

FIGS. 4A and 4B depict a schematic representation of the mold-tool system (100); and

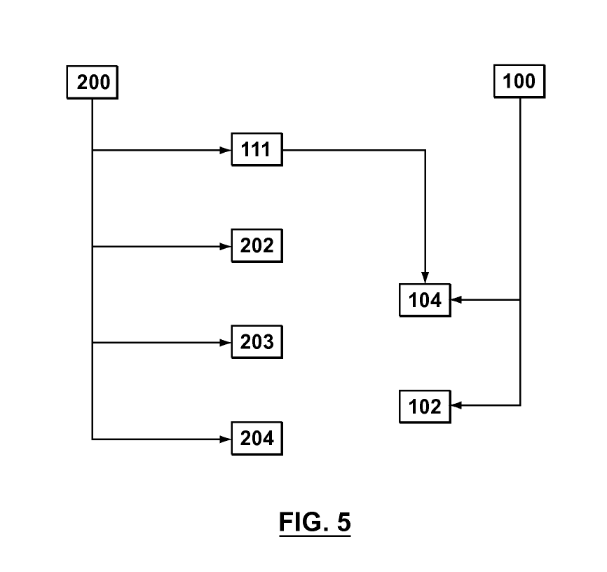

FIG. 5 depicts the schematic representation of the controller (200) for use with the mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 2A and 2B depict a schematic representation of a mold-tool system (100) according to the first example. The mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The mold-tool system (100) includes (but is not limited to): a runner assembly (102), and a retractable-support assembly (104). The retractable-support assembly (104) is configured to partially reduce a support force (107) to the runner assembly (102), so that heat loss from the runner assembly (102) is reduced at least in part. The definition of “being configured to partially reduce the support force (107)” is as follows: the retractable-support assembly (104) becomes at least partially unloaded from the runner assembly (102) at some time during a cycle time of the mold-tool system (100); that is, the retractable-support assembly (104) provides, during an injection operation of the runner assembly (102), a support force to the runner assembly (102). The injection operation is an operation in which a melt is injected through the runner system to the mold assembly. However, during a non-injection operation the runner assembly (102), the retractable-support assembly (104) reduces the amount of support force to the runner assembly (102) while still maintaining support so as to keep the runner assembly (102) stationary during the non-injection operation. The non-injection operation is an operation in which the injection force (106) is not applied to the runner assembly (102).

Generally, the retractable-support assembly (104) is configured to partially reduce application of the support force (107) to the runner assembly (102) relative to application of the injection force (106) to the runner assembly (102). More specifically, the retractable-support assembly (104) is configured to: (i) partially reduce application of the support force (107) to the runner assembly (102) while the runner assembly (102) operates under a non-injection operation in which the injection force (106) is not received by the runner assembly (102), and (ii) partially increase application of the support force (107) to the runner assembly (102) while the runner assembly (102) operates under an injection operation in which the injection force (106) is received by the runner assembly (102).

According to one approach, the retractable-support assembly (104) is configured to partially reduce application of the support force (107) to the runner assembly (102) responsive to removal of the injection force (106) from the runner assembly (102). According to another approach, the retractable-support assembly (104) is configured to partially reduce application of the support force (107) to the runner assembly (102) after removal of the injection force (106) from the runner assembly (102). The retractable-support assembly (104) may partially reduce application of the support force (107) to the runner assembly (102) under several cases or situations or conditions.

Under a first case, the retractable-support assembly (104) is configured to partially reduce application of the support force (107) to the runner assembly (102) responsive to removal of the injection force (106) from the runner assembly (102). That is, while the injection force (106) is applied to the runner assembly (102), the retractable-support assembly (104) remains loaded to the runner assembly (102). To be “loaded” means that the retractable-support assembly (104) provides enough reactive force, that is the support force (107), which counter acts (opposes) the injection force (106) applied to the runner assembly (102) so that the runner assembly (102) remains statically positioned while the injection force (106) is applied. A melt preparation device, such as an extruder (not depicted but known), applies the injection force (106) to the runner assembly (102).

In addition, when the injection force (106) is no longer applied to the runner assembly (102), the retractable-support assembly (104) may respond by becoming unloaded (at least in part) from the runner assembly (102). To be “unloaded” means that the retractable-support assembly (104) provides, when the injection force (106) is not applied to the runner assembly (102), a relatively smaller support force (107)—that is, “smaller” in comparison to the amount of support force (107) that was provided while the injection force (106) was applied. By having the retractable-support assembly (104) provide a relatively smaller support force when the injection force (106) is not applied, heat is less likely to be transferred or removed from the runner assembly (102) thereby reducing (at least in part) the wastage of heat, and/or reducing (at least in part) melt-flow variability.

Under a second case, the retractable-support assembly (104) is configured to partially reduce application of the support force (107) to the runner assembly (102) after removal of the injection force (106) from the runner assembly (102). The retractable-support assembly (104) may be deactivated any time after the injection force (106) is removed (being indicative of removal) or not applied. It will be appreciated that the actuation of the retractable-support assembly (104) may be performed relative to when the injection force (106) is being applied. That is, the retractable-support assembly (104) is configured to partially reduce application of the support force (107) to the runner assembly (102) relative to application of the injection force (106) to the runner assembly (102). This arrangement may allow for providing support before the injection load is are achieved, and can also maintain support until after injection loads become removed.

The runner assembly (102) may include the manifold assembly (36) and/or the nozzle assembly (26), and/or the manifold assembly (36) in combination with the nozzle assembly (26), depending on what the end user desires.

During the injection phase, the molding material receives the injection force (106) so that the molding material may be injected (pushed) through the runner assembly (102). The injection force (106) is then transferred, at least in part, to the runner assembly (102). In order to keep the runner assembly (102) stationary while the molding material is pushed through, the retractable-support assembly (104) provides a counterbalancing (opposing) force to the runner assembly (102) at various points of contact. Some heat is transferred from the runner assembly (102) to the retractable-support assembly (104) via the points of contact. Heaters connected with the runner assembly (102) are used to supply the heat that becomes transferred or lost from the runner assembly (102) via the points of connection to the retractable-support assembly (104). So it is understood that during the injection phase, the retractable-support assembly (104) provides a support load (also called a force, a counterbalancing load, a counterbalancing force, etc) to the runner assembly (102). Specifically, the retractable-support assembly (104) is configured to securely support the runner assembly (102) responsive to application of the injection force (106) to the runner assembly (102).

Anytime other than during the injection phase, the retractable-support assembly (104) unloads, at least in part. To “unload” means that the retractable-support assembly (104) reduces (at least in part or entirely) the support load applied to the runner assembly (102). The reason for this arrangement is to reduce the amount of heat that is transferred from the runner assembly (102) to the retractable-support assembly (104) via the points of contact during anytime other than the injection phase, so that the heaters connected with the runner assembly (102) may provide less heat to the runner assembly (102).

For example, as depicted in the top left-hand corners of FIGS. 2a and 2B, the runner assembly (102) includes (but is not limited to) the manifold assembly (36) that has the back-up insulator (34). In addition, the retractable-support assembly (108) includes (but is not limited to): (i) a stationary plate (110), and (ii) an actuator (111), such as an active element (112) for example. The stationary plate (110) may be also called a stationary support. The stationary plate (110) may also be called a backing plate, etc. The active element (112) is attached to the stationary plate (110) and faces the manifold assembly (36). The active element (112) is configured to: (i) securely contact the back-up insulator (34) of the manifold assembly (36) responsive to the active element (112) receiving a contact-control signal to contact (that is expand and contact), in which the contact-control signal is indicative of application of the injection force (106), and (ii) retract so as to at least partially unload from the back-up insulator (34) of the manifold assembly (36) responsive to the active element (112) receiving a retraction-control signal to contract, in which the retraction-control signal is indicative of the removal of the injection force (106).

It will be appreciated that more generally, the active element (112) does not have to interact with the back-up insulator (34), and that generally speaking the active element (112) may be configured to: (i) securely contact the manifold assembly (36) responsive to the active element (112) receiving a contact-control signal to contact, and (ii) retract so as to at least partially unload from the manifold assembly (36) responsive to the active element (112) receiving a retraction-control signal to contract.

The active element (112) may include a piezoelectric material (for example). Piezoelectricity is the ability of some materials (notably crystals and certain ceramics) to generate an electric field or electric potential in response to applied mechanical stress. The effect is closely related to a change of polarization density within the material's volume. If the material is not short-circuited, the applied stress induces a voltage across the material. The piezoelectric effect is reversible in that materials exhibiting the direct piezoelectric effect (the production of an electric potential when stress is applied) also exhibit the reverse piezoelectric effect (the production of stress and/or strain when an electric field is applied).

Also, the active element (112) may include a magnetostrictive material (as an alternative example). Magnetostriction is a property of ferromagnetic materials that causes them to change their shape or dimensions when subjected to a magnetic field. Also, the active element (112) may include (by way of example) a shape-memory alloy. A shape memory alloy (SMA, smart metal, memory metal, memory alloy, muscle wire, smart alloy) is an alloy that “remembers” its original, cold, forged shape, and which returns to that shape after being deformed by applying heat. This material is a lightweight, solid-state alternative to conventional actuators such as hydraulic, pneumatic, and motor-based systems. Shape memory alloys have applications in industries including medical and aerospace. The active element (112) may also include (by way of example) magnetic-based SMAs otherwise also called ferromagnetic shape memory alloys (FSMA), which are ferromagnetic materials exhibiting large changes in shape and size under the influence of an applied magnetic field due to martensitic phase transformation.

For example, as depicted in the bottom left-hand corners of FIGS. 2a and 2B, the runner assembly (102) includes (but is not limited to) a nozzle assembly (26) having a locating insulator (28). For this case, the active element (112) is attached to the stationary plate (110), and the active element (112) is configured to: (i) securely contact the locating insulator (28) of the nozzle assembly (26) responsive to the active element (112) receiving a contact-control signal to contact (by way of expansion), and (ii) retract so as to at least partially unload from the locating insulator (28) of the nozzle assembly (26) responsive to the active element (112) receiving a retraction-control signal to contract.

It will be appreciated that more generally, the active element (112) does not have to interact with the locating insulator (28), and that generally speaking the active element (112) may be configured to: (i) securely contact the nozzle assembly (26) responsive to the active element (112) receiving a contact-control signal to contact; and (ii) retract so as to at least partially unload from the nozzle assembly (26) responsive to the active element (112) receiving a retraction-control signal.

For example, as depicted in the top right-hand corners of FIGS. 2a and 2B, the runner assembly (102) includes (but is not limited to) the manifold assembly (36) having a cylinder (14) and a back-up pad (18). For this case, the active element (112) is configured to: (i) securely contact the back-up pad (18) of the cylinder (14) responsive to the active element (112) receiving a contact-control signal to contact, and (ii) retract so as to at least partially unload from the back-up pad (18) of the cylinder (14) responsive to the active element (112) receiving a retraction-control signal.

It will be appreciated that more generally, the active element (112) does not have to interact with the back-up pad (18) of the cylinder (14), and that generally speaking the active element (112) may be configured to: (i) securely contact the cylinder (14) responsive to the active element (112) receiving a contact-control signal to contact; and (ii) retract so as to at least partially unload from the cylinder (14) responsive to the active element (112) receiving a retraction-control signal.

FIGS. 2C and 2D depict the schematic representation of the mold-tool system (100) according to another example. The retractable-support assembly (104) operates on central-locating insulator (140), which is connected to a central portion of the runner assembly (102). Specifically, the active element (112) is shown being operable with the central-locating insulator (140).

FIGS. 3A and 3B depict the schematic representation of the mold-tool system (100) according to another example. In this case, the mold-tool system (100) is set up such that the runner assembly (102) includes a manifold assembly (36) having a back-up insulator (34). The runner assembly (102) also has the retractable-support assembly (108) includes: (i) a stationary plate (110), and (ii) the actuator (111), such as an actuator (120) for example, that is coupled to the stationary plate (110). The actuator (120) is configured to: (i) securely contact the back-up insulator (34) of the manifold assembly (36) responsive to the actuator (120) receiving a contact-control signal to contact, and (ii) retract so as to at least partially unload from the back-up insulator (34) of the manifold assembly (36) responsive to the actuator (120) receiving a retraction-control signal to contract. An input line (124) and an output line (126) are use to bring and take away a fluid that is used to interact with the actuator (120).

It will be appreciated that more generally, the actuator (120) does not have to interact with the back-up insulator (34) of the manifold assembly (36), and that generally speaking the actuator (120) may be configured to: (i) securely contact the manifold assembly (36) responsive to the actuator (120) receiving a contact-control signal, and (ii) retract so as to at least partially unload from the manifold assembly (36) in response to the actuator (120) receiving a retraction-control signal to contract.

By way of example, the actuator (120) may include an hydraulic actuator, and other types of actuators may be adapted for use. The hydraulic actuator provides an example of using fluid pressure to actuate, and that t he fluid may be air, hydraulic or any other type of fluid. The stroke of the actuator (120) may be minimal, such as approximately 50 microns, which would be just enough to disrupt heat transfer or the flow of heat away from the manifold assembly (36).

FIGS. 4A and 4B depict the schematic representation of the mold-tool system (100) according to another example. In this case, the runner assembly (102) includes the manifold assembly (36). The retractable-support assembly (108) includes: (i) the stationary plate (110), and (ii) an actuator (111), such as a piston assembly (130), for example, that is slidably movable in the manifold assembly (36) and in communication with a melt channel (40) of the manifold assembly (36). By way of example, the piston assembly (130) may include a slidable pin. The piston assembly (130) is configured to: (i) securely contact the stationary plate (110) responsive to the piston assembly (130) receiving application of the injection force (106), and (ii) retract so as to at least partially unload from the stationary plate (110) responsive to the piston assembly (130) not receiving the injection force (106) as a result of the removal of the injection force (106). This example provides a passive way or approach to solving the problem using minimal structure. The resin pressure may be used to actuatably move the retractable-support assembly (108). The stroke of the piston assembly (13) may be minimal, such as approximately 50 microns, once again may be just enough to disrupt heat transfer away from the manifold assembly (36).

### Other Considerations

The retractable-support assembly (108) may be activated to fully support the runner assembly (102) during the injection phase. However, during other times (other than injection phase), the retractable-support assembly (108) may be retracted (or relaxed) so that heat flow from the runner assembly (102) may be reduced or conserved, such as heat flow from the manifold assembly (38) to the stationary plate (110). Displacement may be in the order of 50 microns. This arrangement improves thermal characteristics (balanced flow of resin for example) of the mold-tool system (100), and reduces energy consumption (improves energy conservation) by retracting or relaxing the retractable-support assembly (108) when a full force is not required to be exerted to the runner assembly (102), or components of the runner assembly (102). The technical effects of the above arrangement are: lower power consumption, better thermal uniformity, and/or improved balance. By relaxing or retracting the retractable-support assembly (108) to an appropriate degree during the injection machine cycle, heat losses associated with contact resistance (between the runner system and the structure surrounding the runner system) may be reduced. As the inject/pack/hold portion of the molding cycle is typically less than 25% of the total cycle of the molding system, reductions in power consumption (for heating the runner system) may be attained while improving thermal characteristics of the runner system (and thus improve balance of the runner system). The retractable-support assembly (108) may be actuated when required to improve efficiency due to reduced heat losses. Actual movement may be minimal and may be accomplished by a variety of actuation principles. The retractable-support assembly (108) may be arranged using a variety of actuation techniques. Control of the actuation may be performed in a machine controller or by using an independent support controller.

FIG. 5 depicts the schematic representation of the controller (200) for use with the mold-tool system (100). The controller (200) includes (but is not limited to): (i) a processor (202) coupled to the retractable-support assembly (104), and (ii) a controller-usable medium (204) coupled with the processor (202). The controller-usable medium (204) has instructions for directing the processor (202) to control the retractable-support assembly (104).

### Additional Description

The following clauses (1) to (23) provide further description of the embodiments.
(1). A mold-tool system (100), comprising:
   a runner assembly (102); and
   a retractable-support assembly (104) being configured to partially reduce a support force (107) to the runner assembly (102), so that heat loss from the runner assembly (102) is reduced at least in part.
(2). The mold-tool system (100) of clause (1), wherein:
   the retractable-support assembly (104) is configured to partially reduce application of the support force (107) to the runner assembly (102) relative to application of an injection force (106) to the runner assembly (102).
(3). The mold-tool system (100) of any preceding clause, wherein:
   the retractable-support assembly (104) is configured to:
      partially reduce application of the support force (107) to the runner assembly (102) while the runner assembly (102) operates under a non-injection operation in which an injection force (106) is not received by the runner assembly (102); and
      partially increase application of the support force (107) to the runner assembly (102) while the runner assembly (102) operates under an injection operation in which the injection force (106) is received by the runner assembly (102).
(4). The mold-tool system (100) any preceding clause, wherein:
   the retractable-support assembly (104) is configured to partially reduce application of the support force (107) to the runner assembly (102) responsive to removal of an injection force (106) from the runner assembly (102).
(5). The mold-tool system (100) any preceding clause, wherein:
   the retractable-support assembly (104) is configured to partially reduce application of the support force (107) to the runner assembly (102) after removal of an injection force (106) from the runner assembly (102).
(6). The mold-tool system (100) any preceding clause, wherein:
   the retractable-support assembly (104) is configured to securely support the runner assembly (102) responsive to application of an injection force (106) to the runner assembly (102).
(7). The mold-tool system (100) any preceding clause, wherein:
   the runner assembly (102);
   the retractable-support assembly (108) includes:
      a stationary plate (110); and
      an actuator (111) attached to the stationary plate (110), the actuator (111) being configured to:
         (i) securely contact the runner assembly (102) responsive to the actuator (111) receiving a contact-control signal to contact, the contact-control signal indicative of the application of the injection force (106); and
         (ii) retract so as to at least partially unload from the runner assembly (102) responsive to the actuator (111) receiving a retraction-control signal to contract, the retraction-control signal being indicative of removal of the injection force (106).
(8). The mold-tool system (100) of any preceding clause, wherein:
   the runner assembly (102) includes:
      a manifold assembly (36) having a back-up insulator (34); and
   the retractable-support assembly (108) includes:
      a stationary plate (110); and
      an active element (112) attached to the stationary plate (110), the active element (112) being configured to:
         (i) securely contact the back-up insulator (34) of the manifold assembly (36) responsive to the active element (112) receiving a contact-control signal to contact, the contact-control signal indicative of the application of the injection force (106); and
         (ii) retract so as to at least partially unload from the back-up insulator (34) of the manifold assembly (36) responsive to the active element (112) receiving a retraction-control signal to contract, the retraction-control signal being indicative of removal of the injection force (106).
(9). The mold-tool system (100) of any preceding clause, wherein:
   the runner assembly (102) includes:
      a manifold assembly (36); and
   the retractable-support assembly (108) includes:
      a stationary plate (110); and
      an active element (112) attached to the stationary plate (110), the active element (112) being configured to:
         (i) securely contact the manifold assembly (36) responsive to the active element (112) receiving a contact-control signal to contact, the contact-control signal indicative of the application of the injection force (106); and
         (ii) retract so as to at least partially unload from the manifold assembly (36) responsive to the active element (112) receiving a retraction-control signal to contract, the retraction-control signal being indicative of removal of the injection force (106).
(10). The mold-tool system (100) of any preceding clause, wherein:
   the active element (112) includes:
      a piezoelectric material.
(11). The mold-tool system (100) of any preceding clause, wherein:
   the active element (112) includes:
      a magnetostrictive material.
(12). The mold-tool system (100) of any preceding clause, wherein:
   the active element (112) includes:
      a shape-memory alloy.
(13). The mold-tool system (100) of any preceding clause, wherein:
   the runner assembly (102) includes:
      a nozzle assembly (26) having a locating insulator (28); and
   the retractable-support assembly (108) includes:
      a stationary plate (110); and
      an active element (112) attached to the stationary plate (110), the active element (112) being configured to:
         (i) securely contact the locating insulator (28) of the nozzle assembly (26) responsive to the active element (112) receiving a contact-control signal to contact, the contact-control signal being indicative of application of the injection force (106); and
         (ii) retract so as to at least partially unload from the locating insulator (28) of the nozzle assembly (26) responsive to the active element (112) receiving a retraction-control signal to contract, the retraction-control signal being indicative of removal of the injection force (106).
(14). The mold-tool system (100) of any preceding clause, wherein:
   the runner assembly (102) includes:
      a nozzle assembly (26); and
   the retractable-support assembly (108) includes:
      a stationary plate (110); and
      an active element (112) attached to the stationary plate (110), the active element (112) being configured to:
         (i) securely contact the nozzle assembly (26) responsive to the active element (112) receiving a contact-control signal to contact, the contact-control signal being indicative of application of the injection force (106) to the nozzle assembly (26); and
         (ii) retract so as to at least partially unload from the nozzle assembly (26) responsive to the active element (112) receiving a retraction-control signal, the retraction-control signal being indicative of removal of the injection force (106).
(15). The mold-tool system (100) of any preceding clause, wherein:
   the runner assembly (102) includes:
      a manifold assembly (36) having a cylinder (14) and a back-up pad (18); and
   the retractable-support assembly (108) includes:
      a stationary plate (110); and
      an active element (112) attached to the stationary plate (110), the active element (112) being configured to:
         (i) securely contact the back-up pad (18) of the cylinder (14) responsive to the active element (112) receiving a contact-control signal to contact, the contact-control signal being indicative of application of the injection force (106); and
         (ii) retract so as to at least partially unload from the back-up pad (18) of the cylinder (14) responsive to the active element (112) receiving a retraction-control signal, the retraction-control signal being indicative of removal of the injection force (106).
(16). The mold-tool system (100) of any preceding clause, wherein:
   the runner assembly (102) includes:
      a manifold assembly (36) having a cylinder (14); and
   the retractable-support assembly (108) includes:
      a stationary plate (110); and
      an active element (112) attached to the stationary plate (110), the active element (112) being configured to:
         (i) securely contact the cylinder (14) responsive to the active element (112) receiving a contact-control signal to contact, the contact-control signal being indicative of application of the injection force (106); and
         (ii) retract so as to at least partially unload from the cylinder (14) responsive to the active element (112) receiving a retraction-control signal to contract, the retraction-control signal being indicative of removal of the injection force (106).
(17). The mold-tool system (100) of any preceding clause, wherein:
   the runner assembly (102) includes:
      a manifold assembly (36) having a back-up insulator (34); and
   the retractable-support assembly (108) includes:
      a stationary plate (110); and
      an actuator (120) coupled to the stationary plate (110), the actuator (120) being configured to:
         (i) securely contact the back-up insulator (34) of the manifold assembly (36) responsive to the actuator (120) receiving a contact-control signal to contact, the contact-control signal being indicative of application of the injection force (106); and
         (ii) retract so as to at least partially unload from the back-up insulator (34) of the manifold assembly (36) responsive to the actuator (120) receiving a retraction-control signal to contract, the retraction-control signal being indicative of removal of the injection force (106).
(18). The mold-tool system (100) of any preceding clause, wherein:
   the runner assembly (102) includes:
      a manifold assembly (36); and
   the retractable-support assembly (108) includes:
      a stationary plate (110); and
      an actuator (120) coupled to the stationary plate (110), the actuator (120) being configured to:
         (i) securely contact the manifold assembly (36) responsive to the actuator (120) receiving a contact-control signal, the contact-control signal being indicative of application of the injection force (106); and
         (ii) retract so as to at least partially unload from the manifold assembly (36) in response to the actuator (120) receiving a retraction-control signal to contract, the retraction-control signal being indicative of removal of the injection force (106).
(19). The mold-tool system (100) of any preceding clause, wherein:
   the retractable-support assembly (104) includes:
      an hydraulic actuator.
(20). The mold-tool system (100) of any preceding clause, wherein:
   the runner assembly (102) includes:
      a manifold assembly (36); and
   the retractable-support assembly (108) includes:
      a stationary plate (110); and
      a piston assembly (130) being slidably movable in the manifold assembly (36) and in communication with a melt channel (40) of the manifold assembly (36), the piston assembly (130) being configured to:
         (i) securely contact the stationary plate (110) responsive to the piston assembly (130) receiving the application of the injection force (106); and
         (ii) retract so as to at least partially unload from the stationary plate (110) responsive to the piston assembly (130) not receiving the injection force (106) as a result of removal of the injection force (106).
(21). The mold-tool system (100) of any preceding clause, wherein:
   the retractable-support assembly (104) operates on a central-locating insulator (140), the central-locating insulator (140) being connected to a central portion of the runner assembly (102).
(22). A controller (200) for use with the mold-tool system (100) of any preceding clause, the controller (200) comprising:
   a processor (202) being coupled to the retractable-support assembly (104); and
   a controller-usable medium (204) being coupled with the processor (202), the controller-usable medium (204) having instructions for directing the processor (202) to control the retractable-support assembly (104).
(23). A controller-usable medium (204) for use with a processor (202) of a controller (200) for use with the mold-tool system (100) of any preceding clause, the controller-usable medium (204) comprising: instructions for directing the processor (202) to control the retractable-support assembly (104).

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim. It is noted that the foregoing has outlined the non-limiting embodiments. Thus, although the description is made for particular non-limiting embodiments, the scope of the present invention is suitable and applicable to other arrangements and applications. Modifications to the non-limiting embodiments can be effected without departing from the scope of the independent claims. It is understood that the non-limiting embodiments are merely illustrative.

What is claimed is:

1. A mold-tool system, comprising:
a runner assembly; and
a retractable-support assembly being configured to partially reduce a support force to the runner assembly, so that heat loss from the runner assembly is reduced at least in part.

2. The mold-tool system of claim 1, wherein:
the retractable-support assembly is configured to partially reduce application of the support force to the runner assembly relative to application of an injection force to the runner assembly.

3. The mold-tool system of claim 1, wherein:
the retractable-support assembly is configured to:
partially reduce application of the support force to the runner assembly while the runner assembly operates under a non-injection operation in which an injection force is not received by the runner assembly; and
partially increase application of the support force to the runner assembly while the runner assembly operates under an injection operation in which the injection force is received by the runner assembly.

4. The mold-tool system of claim 1, wherein:
the retractable-support assembly is configured to partially reduce application of the support force to the runner assembly responsive to removal of an injection force from the runner assembly.

5. The mold-tool system of claim 1, wherein:
the retractable-support assembly is configured to partially reduce application of the support force to the runner assembly after removal of an injection force from the runner assembly.

6. The mold-tool system of claim 1, wherein:
the retractable-support assembly is configured to securely support the runner assembly responsive to application of an injection force to the runner assembly.

7. The mold-tool system of claim 3, wherein:
the runner assembly;
the retractable-support assembly includes:
a stationary plate; and
an actuator attached to the stationary plate, the actuator being configured to:
(i) securely contact the runner assembly responsive to the actuator receiving a contact-control signal to contact, the contact-control signal indicative of the application of the injection force and
(ii) retract so as to at least partially unload from the runner assembly responsive to the actuator receiving a retraction-control signal to contract, the retraction-control signal being indicative of removal of the injection force.

8. The mold-tool system of claim 3, wherein:
the runner assembly includes:
a manifold assembly having a back-up insulator; and
the retractable-support assembly includes:
a stationary plate; and
an active element attached to the stationary plate, the active element being configured to:
(i) securely contact the back-up insulator of the manifold assembly responsive to the active element receiving a contact-control signal to contact, the contact-control signal indicative of the application of the injection force; and
(ii) retract so as to at least partially unload from the back-up insulator of the manifold assembly responsive to the active element receiving a retraction-control signal to contract, the retraction-control signal being indicative of removal of the injection force.

9. The mold-tool system of claim 3, wherein:
the runner assembly includes:
a manifold assembly; and
the retractable-support assembly includes:
a stationary plate; and
an active element attached to the stationary plate, the active element being configured to:
(i) securely contact the manifold assembly responsive to the active element receiving a contact-control signal to contact, the contact-control signal indicative of the application of the injection force; and
(ii) retract so as to at least partially unload from the manifold assembly responsive to the active element receiving a retraction-control signal to contract, the retraction-control signal being indicative of removal of the injection force.

10. The mold-tool system of any one of claim 8 and claim 9, wherein:
the active element includes:
a piezoelectric material.

11. The mold-tool system of any one of claim 8 and claim 9, wherein:
the active element includes:
a magnetostrictive material.

12. The mold-tool system of any one of claim 8 and claim 9, wherein:
the active element includes:
a shape-memory alloy.

13. The mold-tool system of claim 3, wherein:
the runner assembly includes:
a nozzle assembly having a locating insulator; and
the retractable-support assembly includes:
a stationary plate; and
an active element attached to the stationary plate, the active element being configured to:
(i) securely contact the locating insulator of the nozzle assembly responsive to the active element receiving a contact-control signal to contact, the contact-control signal being indicative of application of the injection force; and
(ii) retract so as to at least partially unload from the locating insulator of the nozzle assembly responsive to the active element receiving a retraction-control signal to contract, the retraction-control signal being indicative of removal of the injection force.

14. The mold-tool system of claim 3, wherein:
the runner assembly includes:
to a nozzle assembly; and
the retractable-support assembly includes:
a stationary plate; and
an active element attached to the stationary plate, the active element being configured to:
(i) securely contact the nozzle assembly responsive to the active element receiving a contact-control signal to contact, the contact-control signal being indicative of application of the injection force to the nozzle assembly; and
(ii) retract so as to at least partially unload from the nozzle assembly responsive to the active element receiving a retraction-control signal, the retraction-control signal being indicative of removal of the injection force.

15. The mold-tool system of claim 3, wherein:
the runner assembly includes:
a manifold assembly having a cylinder and a back-up pad; and
the retractable-support assembly includes:
a stationary plate; and
an active element attached to the stationary plate, the active element being configured to:
(i) securely contact the back-up pad of the cylinder responsive to the active element receiving a contact-control signal to contact, the contact-control signal being indicative of application of the injection force; and
(ii) retract so as to at least partially unload from the back-up pad of the cylinder responsive to the active element receiving a retraction-control signal, the retraction-control signal being indicative of removal of the injection force.

16. The mold-tool system of claim 3, wherein:
the runner assembly includes:
a manifold assembly having a cylinder; and
the retractable-support assembly includes:
a stationary plate; and
an active element attached to the stationary plate, the active element being configured to:
(i) securely contact the cylinder responsive to the active element receiving a contact-control signal to contact, the contact-control signal being indicative of application of the injection force; and
(ii) retract so as to at least partially unload from the cylinder responsive to the active element receiving a retraction-control signal to contract, the retraction-control signal being indicative of removal of the injection force.

17. The mold-tool system of claim 3, wherein:
the runner assembly includes:
a manifold assembly having a back-up insulator; and
the retractable-support assembly includes:
a stationary plate; and
an actuator coupled to the stationary plate, the actuator being configured to:
(i) securely contact the back-up insulator of the manifold assembly responsive to the actuator receiving a contact-control signal to contact, the contact-control signal being indicative of application of the injection force; and
(ii) retract so as to at least partially unload from the back-up insulator of the manifold assembly responsive to the actuator receiving a retraction-control signal to contract, the retraction-control signal being indicative of removal of the injection force.

18. The mold-tool system of claim 3, wherein:
the runner assembly includes:
a manifold assembly; and
the retractable-support assembly includes:
a stationary plate; and
an actuator coupled to the stationary plate, the actuator being configured to:
(i) securely contact the manifold assembly responsive to the actuator receiving a contact-control signal, the contact-control signal being indicative of application of the injection force; and
(ii) retract so as to at least partially unload from the manifold assembly in response to the actuator receiving a retraction-control signal to contract, the retraction-control signal being indicative of removal of the injection force.

19. The mold-tool system of claim 1, wherein:
the retractable-support assembly includes:
an hydraulic actuator.

20. The mold-tool system of claim 3, wherein:
the runner assembly includes:
a manifold assembly; and
the retractable-support assembly includes:
a stationary plate; and
a piston assembly being slidably movable in the manifold assembly and in communication with a melt channel of the manifold assembly, the piston assembly being configured to:
(i) securely contact the stationary plate responsive to the piston assembly receiving the application of the injection force; and
(ii) retract so as to at least partially unload from the stationary plate responsive to the piston assembly not receiving the injection force as a result of removal of the injection force.

21. The mold-tool system of claim 1, wherein:
the retractable-support assembly operates on a central-locating insulator, the central-locating insulator being connected to a central portion of the runner assembly.

22. A controller for use with the mold-tool system of claim 1, the controller comprising:
a processor being coupled to the retractable-support assembly; and
a controller-usable medium being coupled with the processor, the controller-usable medium having instructions for directing the processor to control the retractable-support assembly.

23. A controller-usable medium for use with a processor of a controller for use with the mold-tool system of claim 1, the controller-usable medium comprising:
instructions for directing the processor to control the retractable-support assembly.
